(19) United States
(12) Patent Application Publication
(10) Pub. No.: US 2007/0162876 A1
(43) Pub. Date: Jul. 12, 2007

(54) Contextual album browsing

(76) Inventor: Timothy B. Quirk, Oakland, CA (US)

Correspondence Address: RealNetworks, Inc., Suite 1000, 2601 Elliott Avenue, Seattle, WA, 96121, US

(21) Appl. No.: 11/321,748

(22) Filed: Dec. 29, 2005

(51) Int. Cl. G06F 3/048; G06F 17/00

(52) U.S. Cl. 715/853; 707/104.1

(57) ABSTRACT

Methods and apparatuses for facilitating a user in browsing albums of digital media data in accordance with an indicated criterion applied in an indicated context are described herein.

### TECHNICAL FIELD

Embodiments of the present invention relate to the field of media content provision, in particular, to contextual browsing of albums of digital media data.

### BACKGROUND

Advances in microprocessor and related technologies have led to wide spread deployment and adoption of powerful general purpose as well as special purpose computing devices. Today, most of these computing devices are multi-media, i.e. video, audio, and graphics enabled. Special purpose computing devices include but are not limited to digital camcorders, set-top boxes, and digital versatile disk (DVD) players.

Advances in networking, telecommunication, satellite, content serving and other related technologies have also led to increases in online multi-media content provision, including online purchases, as well as on demand and/or real time delivery of video/or audio content, over private and/or public networks, such as the Internet.

With the multitude of media contents available, it has become increasingly difficult for users to locate and consume media contents of their preferences.

### DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of the invention, in accordance with various embodiments;

FIGS. 2-4 illustrate a user interface having user interface elements for facilitating contextual browsing of albums of digital media data, including user interface elements for indicating a context within which an indicated criteria is to be applied for browsing albums of digital media data, in accordance with various embodiments of the invention;

FIG. 5 illustrates the user interface element for indicating a criteria to be applied in browsing albums of digital media data in further detail, in accordance with various embodiments of the invention;

FIGS. 6-7 illustrate the user interface element for browsing and sampling albums of digital media data, in accordance with various embodiments of the invention;

FIG. 8 illustrates a flow chart view of selected operations of album browsing logic of FIG. 1, in accordance with various embodiments; and

FIG. 9 illustrates an example computer readable medium, suitable for use to facilitate practice of the present invention, in accordance with various embodiments.

### DETAILED DESCRIPTION OF ILLUSTRATIVE EMBODIMENTS

Illustrative embodiments of the present invention include but are not limited to methods and apparatuses for contextual browsing of albums of digital encoded media data.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

The phrase “A/B” means “A or B”. The phrase “A and/or B” means “(A), (B), or (A and B)”. The phrase “at least one of A, B and C” means “(A), (B), (C), (A and B), (A and B), (B and C) or (A, B and C)”. The phrase “(A) B” means “(B) or (A B)”, that is, A is optional.

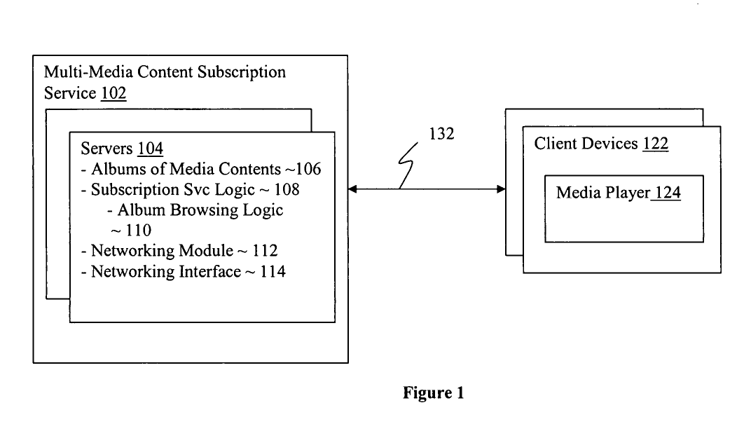

FIG. 1 illustrates an overview of the present invention, in accordance with various embodiments. As illustrated, for the embodiments, a multi-media content subscription service 102 is equipped with one or more servers 104 to provide media content subscription service to user subscribers, using client devices 122 having media players 124. Servers 104 are equipped with albums of media contents 106 and subscription service logic 108 for facilitating a user in selectively consuming various media contents of albums 106, and in particular, album browsing logic 110 for facilitating a user in browsing albums 106. As will be described in more detail below, album browsing logic 110 is configured to facilitate a user in indicating a criterion to be applied to browsing albums 106, and a context within which the criterion is to be applied. In various embodiments, subscription service logic 108 (including album browsing logic 110) is configured for operation with a variety of media players 124. As a result, a user is more likely to be able to browse albums 106 in a more user friendly manner.

Additionally, in various embodiments, a portion of subscription service logic 108 (including album browsing logic 110) may configured to operate on client devices 122, including being integrated with media players 124. The portion of subscription service logic 108 (including album browsing logic 110) to be operated on client devices 122 may be pre-installed on client devices 122 or downloaded onto client devices 122 substantially in real time. However, for ease of understanding, the remaining description will be substantially in the context of subscription service logic 108 (including album browsing logic 110) operating on servers 104. The description is not to be read as limiting on the present invention.

The term “media content subscription service” as used herein refers to a service which, in consideration of a user's payment (electronically or otherwise) of a subscription fee (e.g. lifetime membership) or continuing payments of periodic subscription fees (e.g. monthly), offers the user its collection of media content for the user's enjoyment. The “user” may be referred to as a subscriber of the subscription service. The offered service may be for a subset of the collection, where, for example, there are different categories of subscribers with different levels of subscription fees; however, the quid pro quo between the user and the service is not at a title or an album level. An example of such subscription service is the Rhapsody subscription service offered by RealNetworks, Inc. of Seattle, Wash., assignee of the present invention.

The term “album” as used herein refers to a conventional physical as well a logical organization of media contents, which may be, for example, audio and/or video media contents. An album may be referred to as having a number of titles of audio/video contents. In the case of audio media contents, an album may also be referred to as having a number of tracks of audio contents.

Further, the media content offered by a media content subscription service for their subscribers' consumption are typically characterized by, though not necessarily required for all offered media contents, integral digital rights management with the media contents. In various embodiments, the integral digital rights management may include identifiers or keys associated with the subscribers, devices associated with the subscribers, and/or the media contents themselves. The media content may be digitally encoded and/or compressed using known encoding and/or compression techniques (e.g. MPEG layer 3, Advanced Audio coding, Windows Media Audio coding, RealAudio coding, etc.) as part of the subscription service.

Still referring to FIG. 1, in various embodiments, client device 122 may be coupled to server 104 via a wide area network (WAN) connection 132 spanning one or more public and/or private networks, like the Internet.

In various embodiments, servers 104 may include networking modules 112 and a networking interface 114 to facilitate coupling to client device 122 over a network connection. Networking modules 112 and networking interface 114 may be practiced with any one of a number of these elements known or to be designed.

In various embodiments, subscription service logic 108, including album browsing logic 110, may be implemented in hardware or software, in part or in whole. Hardware embodiments may be implemented via Application Specific Integrated Circuits (ASIC) or reconfigurable circuits (such as Field Programmable Gate Arrays (FPGA). Software embodiments may be implemented using any one of or combinations of a number of programming languages.

In various embodiments, native server(s) 104 (without media content files 106 and subscription service logic 108) may be one or more servers offered by IBM of Armonk, N.Y., or Sun Microsystems of Mountain View, Calif., and so forth.

In various embodiments, media player 124 may be any one of a number of media players known or to be designed, including Real Player available from RealNetworks, Inc. Media player 124 may be operating on a client electronic device 22 having an operating system and a display. In various embodiments, client electronic device(s) 122 may be, for example, one or more desktop or portable laptop computers available from Hewlett Packard of Palo Alto, Calif., or from Gateway Computer of Sioux Falls, S. Dak. Other embodiments of the client electronic device 122 may include, for example, a portable device assistants or cellular telephones.

Except for the logic in support of the improved, more user friendly manner of album browsing, various aspects of the logic for providing the media content subscription service, such as encoding/decoding and storing of the digital media content, streaming and transferring of the digital media content, and so forth, may be implemented with anyone of a number of corresponding techniques generally known or to be designed.

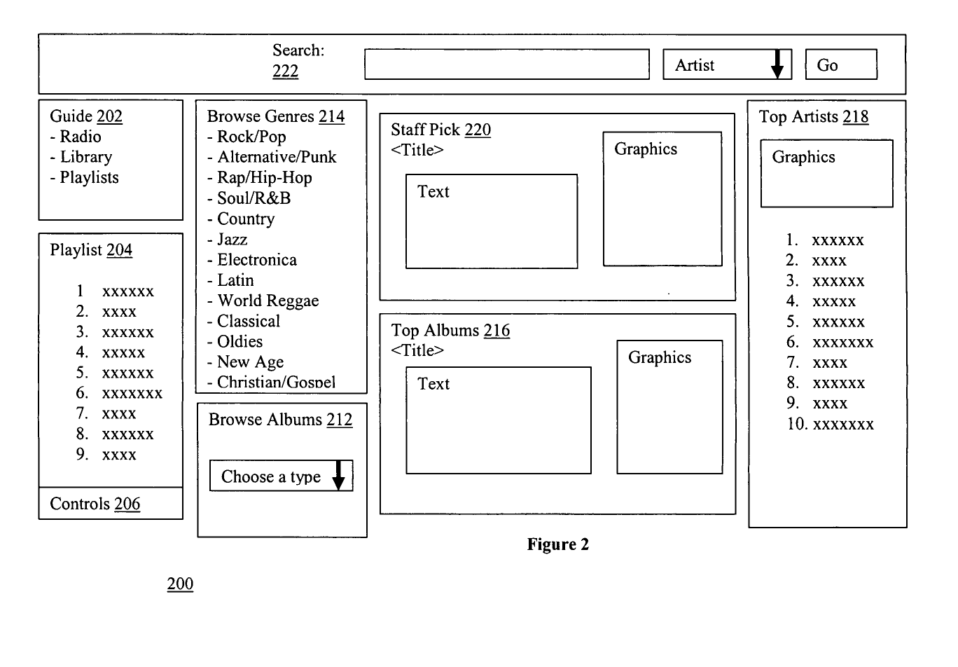

Referring now to FIGS. 2-7, wherein a number of block diagrams illustrating selective aspects of a user interface provided by album browsing logic 110 to facilitate browsing of albums by a user, in accordance with various embodiments. For ease of understanding, the embodiments will be illustrated in the context of browsing albums of audio media contents. However, the invention is not so limited, and may be practiced to browse albums of video media contents, or both video and audio media contents. As mentioned earlier, the audio and/or video media contents may comprise of encoded and/or compressed digital media data, with or without digital rights management data and/or logic.

As illustrated, for the embodiments, example user interface 200 includes various user interface elements to facilitate a user in indicating a criterion to be applied to album browsing, including indicating a context within which the criterion is to be applied. Further, for the embodiments, example user interface 200 further includes various user interface elements to facilitate a user in sampling an audio track, and/or adding audio tracks (sampled or otherwise) to the user's playlist, on identification of an album of interest, or one or more tracks of audio contained therein.

Referring now more specifically to FIG. 2, as illustrated, for the embodiments, example user interface 200 includes a Guide user interface element 202 for facilitating a user in indicating whether the user desires to invoke a Radio feature, enter a Media Content Library, or view and/or edit the user's Playlist(s). The Radio and Media Content Library may be implemented in any one of a number of manners. The contextual album browsing of the invention may be practiced without also practicing these features. Similarly, the context album browsing of the invention may be practiced with other features in addition to these features.

As illustrated, for the embodiments, example user interface 200 further includes a Playlist user interface element 204 having various controls 206 to display, and facilitating operations, such as scroll, play, edit, on the playlist or entries (i.e. titles/tracks) within with playlist.

In various embodiments, Guide 202 and Playlist 204 may be persistently displayed in all instantiations of example user interface 200, or substantially persistent in most instantiations of example user interface 200.

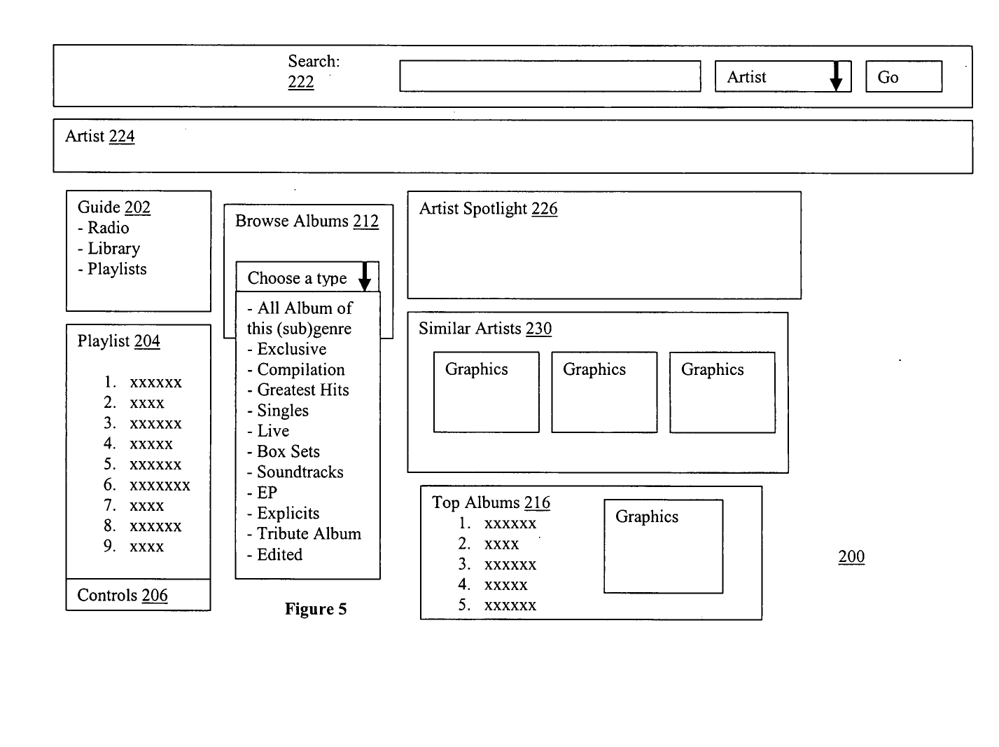

Continuing to referring to FIG. 2, example user interface 200 includes, in particular, Browse Album user interface element 212 to facilitate a user in browsing albums, including indicating a criterion to be applied. For the illustrated embodiments, Browse Album 212 includes a list of pre-selected criteria available for the user to select. More specifically, for the embodiments, the pre-selected criteria are presented in the form of a drop-list (FIG. 5).

Referring now briefly to FIG. 5, for the illustrated embodiments, the criteria include
an “Exclusive” criterion of browsing only an exclusive collection of albums of digital media data,
a “Compilation” criterion of browsing only a compiled collection of albums of digital media data,
a “Greatest Hits” criterion of browsing only albums of digital media data containing greatest hits,
a “Singles” criterion of browsing only albums of digital media data containing singles,
a “Live” criterion of browsing only albums of digital media data containing recorded live performances,
a “Box Sets” criterion of browsing only albums of digital media data packaged in box sets,
a “Soundtracks” criterion of browsing only albums of digital media data containing soundtracks,
an “Explicits” criterion of browsing only albums of digital media data containing explicit contents,
a “Tribute Album” criterion of browsing only albums of digital media data containing tributes, and
an “Edited” criterion of browsing only albums of edited digital media data.

In alternate embodiments, Browse Albums 212 may be practiced with more or less pre-selected criteria. In various embodiments, Browse Albums 212 is persistently displayed in all instantiations of example user interface 200, while the user is browsing albums.

Referring now again generally to FIGS. 2-7, for the illustrative embodiments, example user interface 200 further includes a number of other user interface elements to facilitate a user in indicating a context to apply the indicated criteria. As illustrated, these other interface elements may include Browse Genres/Subgenres user interface element 214 (FIG. 2-4) for facilitating a user in indicating a genre and, optionally, a subgenre within a selected genre, to apply the indicated browsing criteria.

In various embodiments, Browse Genres/Subgenres 214 includes a number of pre-selected genres for the user to select. In various embodiments, the genres may include a Rock/Pop genre, an Alternative/Punk genre, a Rap/Hip-Hop genre, a Soul/Rhythm and Blue genre, a Country genre, a Jazz genre, an Electronica genre, a Latin genre, a World Reggae genre, a Classical genre, an Oldies genre, a New Age genre, and a Christian/Gospel genre. In alternate embodiments, Browse Genres 214 may include more or less pre-selected genres.

In various embodiments, Browse Subgenres 214 includes a number of pre-selected subgenres for the user to select, for a selected genre. In various embodiments, the subgenres for the Rock/Pop genre may include one or more of an Adult Alternative subgenre, an Adult Contemporary subgenre, an Art and Progressive subgenre, a Blues and Boogie subgenre, a Classic Rock subgenre, a Country Rock subgenre, a Folk Rock subgenre, a Fun Rock subgenre, a Glam subgenre, a Hard Rock subgenre, an Instrumental subgenre, a Jam Rock subgenre, a Latin Pop subgenre, and a Metal subgenre. In alternate embodiments, Browse Subgenres 214 may include more or less pre-selected subgenres for the Rock/Pop genre.

In various embodiments, the subgenres for the Alternative/Punk genre may include one or more of an Alternative Country subgenre, an Alternative Dance subgenre, an Alternative Metal subgenre, a Punk-Funk subgenre, and a Post-Punk subgenre. In alternate embodiments, Browse Subgenres 214 may include more or less pre-selected subgenres for the Alternative/Punk genre.

In various embodiments, the subgenres for the Rap/Hip-Hop genre may include one or more of an Alternative Rap or Hip-Hop subgenre, a Christian Rap or Hip-Hop subgenre, a Comedy Rap or Hip-Hop subgenre, a Crossover Rap or Hip-Hop subgenre, and an East Coast Rap or Hip-Hop subgenre. In alternate embodiments, Browse Subgenres 214 may include more or less pre-selected subgenres for the Rap/Hip-Hop genre.

In various embodiments, the subgenres for the Soul/Rhythm & Blue genre may include one or more of a Classical Rhythm and Blue subgenre, a Contemporary Rhythm and Blue subgenre, a Disco subgenre, a Motown subgenre, and a Soul subgenre. In alternate embodiments, Browse Subgenres 214 may include more or less pre-selected subgenres for the Soul/Rhythm and Blue genre.

In various embodiments, the subgenres for the Country genre may include one or more of a Country Gospel subgenre, a Country Humor subgenre, a Country Pop/Cosmopolitan subgenre, a Country Rock subgenre, and a Country Folk/Bluegrass subgenre. In alternate embodiments, Browse Subgenres 214 may include more or less pre-selected subgenres for the Country genre.

In various embodiments, the subgenres for the Jazz genre may include one or more of an Acid Jazz subgenre, an Avant Garde Jazz subgenre, a Big Band subgenre, a Blues Jazz subgenre, and a Cool or West Coast Jazz subgenre. In alternate embodiments, Browse Subgenres 214 may include more or less pre-selected subgenres for the Jazz genre.

In various embodiments, Browse Genres/Subgenres 214 is non-persistently displayed in selected instantiations of example user interface 200, as appropriate, while user is browsing albums.

Still referring generally to FIGS. 2-7, the other interface elements may further include a Top Albums user interface element 216 and a Top Artists user interface element 218 identifying a number of top albums and a number of top artists, respectively. Typically, “top” is defined in reference to a community, which in some embodiments, may be the community of subscribers of the subscription service. The communities for defining top albums and top artists may be different or the same.

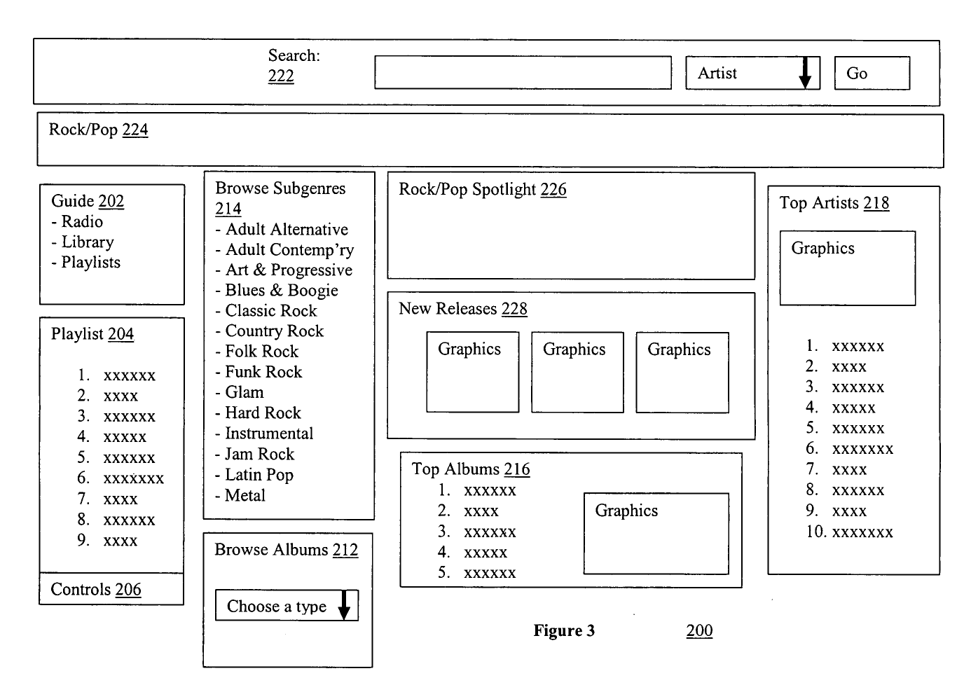

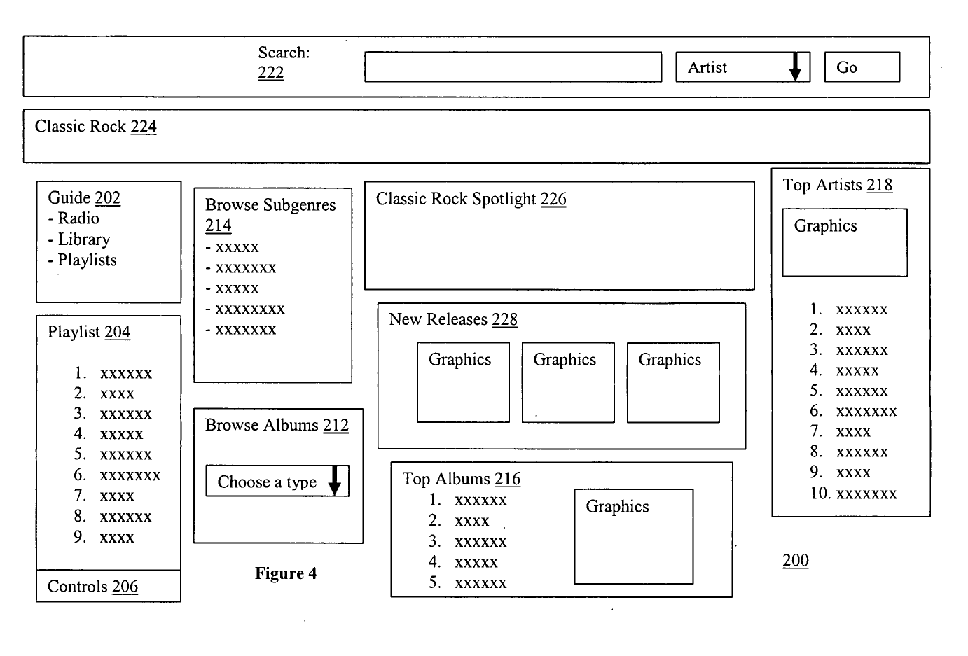

These other interface elements may also include a Staff Pick user interface element 220 (FIG. 2) identifying a number of album recommendations by the staff of the subscription service, respectively. These other interface elements may also include a Spotlight user interface element 226 (FIG. 3-5) and New Releases user interface element 228 (FIG. 3-4) identifying a number of album highlights and recent releases, respectively.

In various embodiments, each of Staff Pick 220, Spotlight 226 and New Release 228 may be non-persistently displayed in selective instantiations of example user interface 200, as desired, while the user is browsing albums.

Still referring generally to FIGS. 2-7, for the illustrative embodiments, example user interface 200 further includes a Search user interface element 222 to facilitate a user in particularizing the context via searches, for example, on preferred artists. For the illustrated embodiments, example user interface 200 further includes an Artist user interface element 224 (FIG. 5) for identifying a selected Artist context, and a Similar Artists user interface element 230 (FIG. 5) for identifying other similar artists to facilitate switching the selected Artist context to another Artist context.

In various embodiments, Artists 224 and Similar Artists 230 may be non-persistently displayed in selective instantiations of example user interface 200, as appropriate, while the user is browsing albums.

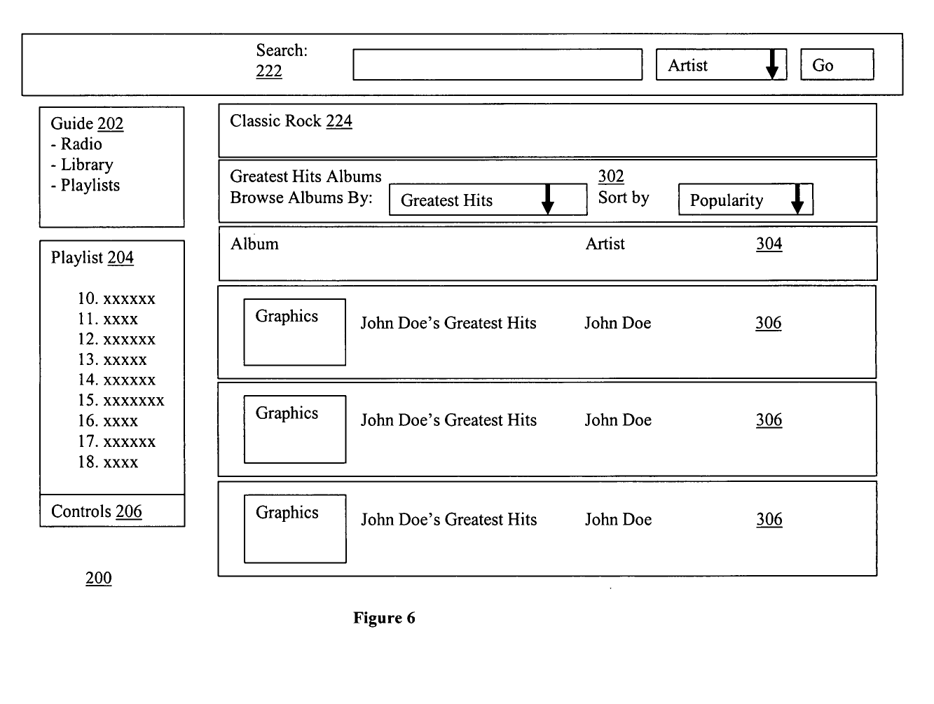

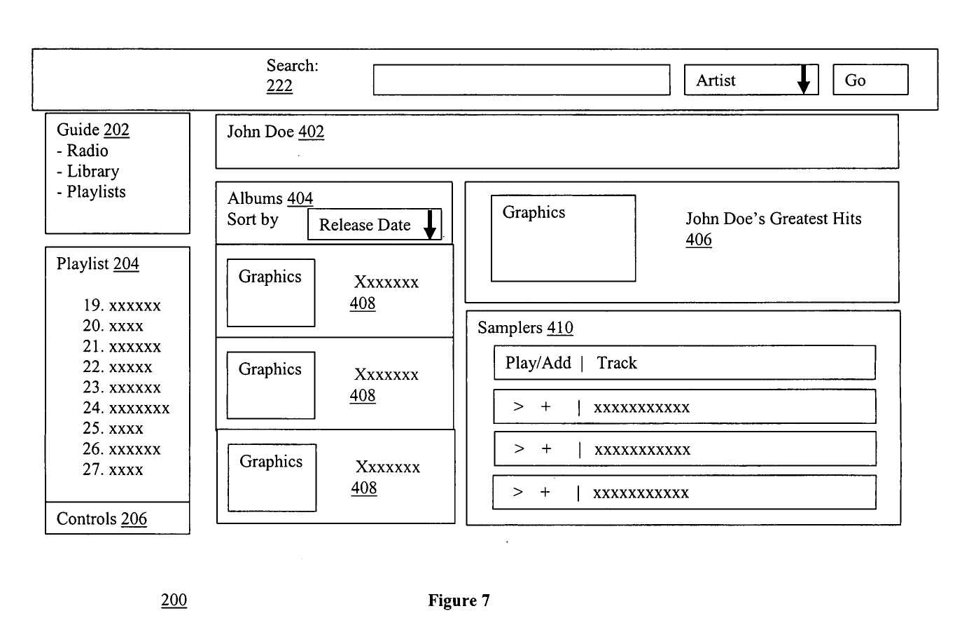

Referring now specifically to FIGS. 6-7, example user interface 200 further includes user interface elements 224, and 302-306 to identify a number of albums 106 meeting the indicated criterion as applied in the indicated context, for the user to browse. Criterion user interface element 302 describes the current criterion being applied, and Context user interface element 224 describes the current context within which the current criterion is applied. Album user interface elements 306 represent albums meeting the current criterion as applied in the current context.

For the illustrated embodiments, Criterion 302 further includes a feature to allow the user to change the current criterion, and the order the albums available for browsing are presented. In various embodiments, the order of presentation may be in the ascending or descending alphabetical order of the artists or the popularity of the albums in accordance with a community.

Still referring to FIGS. 6-7, example user interface 200 further includes user interface elements 402-410 to assist a user in browsing an album, upon selecting an album from the list of albums meeting the current criterion as applied in the current context. In particular, user interface elements 402-410 include Sampler user interface element 410 to facilitate a user in invoking a media player to sample a title/track of a selected album or add the track/title to the user's playlist.

For the illustrated embodiments, Artist user interface element 402 is employed to indicate the artist of the selected album. Album user interface elements 404-408 are employed to identify and highlight other albums of the selected artist, if the selected artist has other albums. Album user interface element 404 may provide a feature to allow the other albums be ordered differently, including by ascending or descending order of the titles, by release dates, and so forth.

Accordingly, a user may use these user interface elements to indicate a criterion to be applied in a context to browse albums of digital media data or digital encoded media data in a relatively user friendly manner.

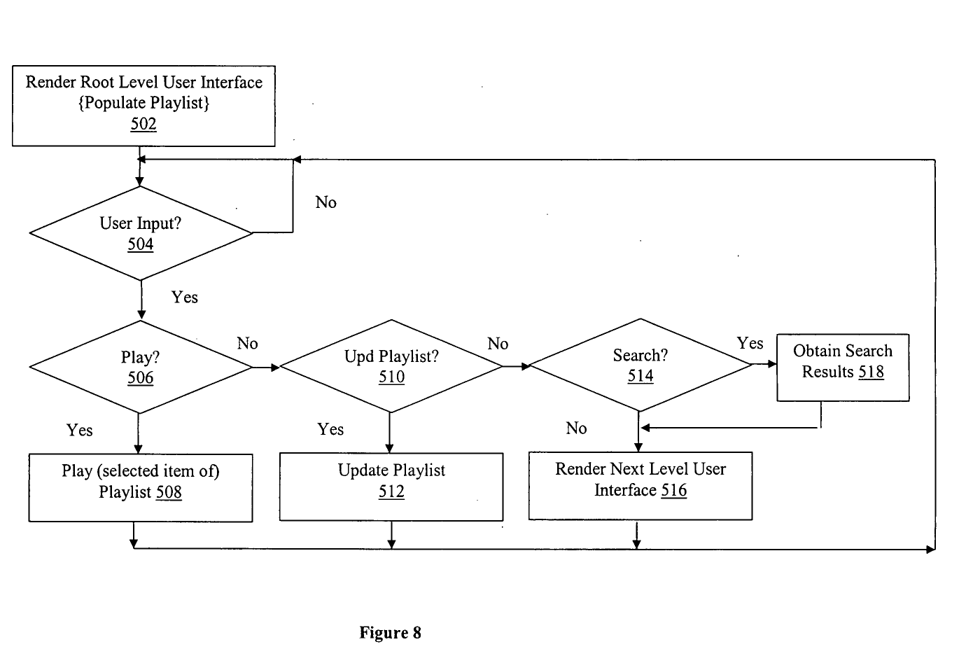

Referring now to FIG. 8 wherein a flow chart view of selected operation of album browsing logic 110, in accordance with various embodiments, is illustrated. As illustrated, when operated by a processor, album browsing logic 110 first renders 502 a root level of a user interface having a number of user interface elements, including an user interface element to facilitate a user in indicating a criterion to be applied in facilitating the user in browsing albums of digital media data. In various embodiments, the root level of the user interface further includes one or more other user interface elements to facilitate the user in establishing a context to bind the application of the indicated criterion. In various embodiments, the root level of the user interface may include a playlist user interface element. For these embodiments, album browsing logic 110 also populates the user's playlist in full or in part. In various embodiments, the root level of the user interface is the user interface of FIG. 1.

Thereafter, album browsing logic 110 waits 504 for user inputs. Next, on receipt of a user input, album browsing logic 110 determines 506 whether the user input is a user instruction to play a selected digital media data. If the result of the determination is affirmative, album browsing logic 110 causes 506 the selected digital media data to be played. In various embodiments, album browsing logic 110 transmits the selected digital media data to a media player.

However, if the user input is not an instruction to play a selected media, album browsing logic 110 further determines 510 whether the user input is a user instruction to update a user playlist. If the result of the determination is affirmative, album browsing logic 110 updates 512 the user's playlist accordingly.

Further, if the user input is not an instruction to update a user's playlist, album browsing logic 110 further determines 514 whether the user input is a user instruction to conduct a search. If the result of the determination is affirmative, album browsing logic 110 performs 518 the search as requested.

Still further, if the user input is not an instruction to perform a search, for the embodiments, album browsing logic 110 infers the user input to be an interaction with one of the displayed user interface elements. Album browsing logic 110 then responds 516 to the user interaction accordingly. For example, if the user interacted with Browse Album 212 of user interface 200 of FIG. 1, album browsing logic 110 may respond by updating the user interface, displaying a drop list of pre-selected criteria, as illustrated in FIG. 5.

Thereafter, album browsing logic 110 returns to wait 504 for another user input. The process continues from there as earlier described with other additional user inputs.

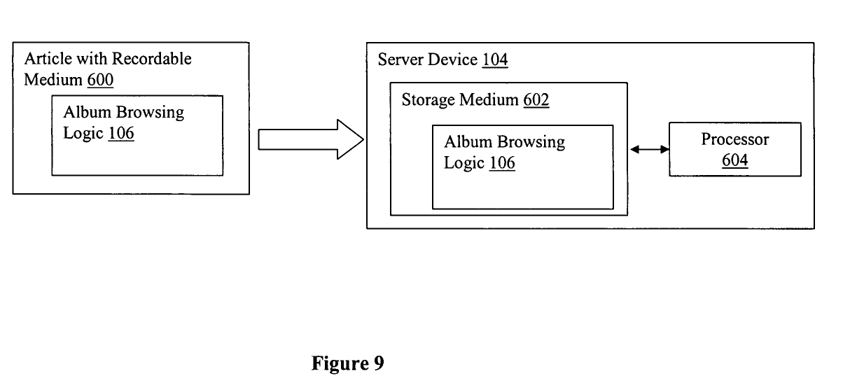

FIG. 9 illustrates an article of manufacture including a recordable medium 600 readable by a computing device, in accordance with various embodiments. Recordable medium 600 has stored therein programming instructions implementing a software embodiment of the earlier described album browsing logic 106.

For these embodiments, server 104 includes storage medium 602 to store at least a portion of a working copying of the programming instructions implementing the software embodiment of album browsing logic 106, and at least one processor 604 coupled to storage medium 602 to execute the programming instructions.

Article 600 may, for example, be a diskette, a compact disk (CD), a DVD or other computer readable medium of the like. In other embodiments, article 600 may be a distribution server distributing album browsing logic 106, via private and/or public networks, such as the Internet. In one embodiment, article 600 is a web server.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. A method comprising:
displaying on a display of an electronic device a first user interface element to facilitate a user in indicating a criterion to be applied in browsing albums of digital media data;
displaying on the display of the electronic device at least a second user interface element to facilitate a user in establishing a context in applying the criterion in browsing albums of digital media data; and
facilitating the user in browsing albums of digital media data based at least on a criterion indicated using the first interface element and a context indicated with said at least second interface element.

2. The method of claim 1, wherein the displaying of a first user interface element to facilitate a user in indicating a criterion comprises displaying a user interface element having a list of criteria for the user to select.

3. The method of claim 2, wherein the displaying of a first user interface element having a list of criteria for the user to select comprises displaying a user interface element having the list of criteria associated with the user interface element as a dropdown list.

4. The method of claim 2, wherein the list of criteria comprises one or more of:
a criterion of browsing only an exclusive collection of albums of digital media data,
a criterion of browsing only a compiled collection of albums of digital media data,
a criterion of browsing only albums of digital media data containing greatest hits,
a criterion of browsing only albums of digital media data containing singles,
a criterion of browsing only albums of digital media data containing recorded live performances,
a criterion of browsing only albums of digital media data packaged in box sets,
a criterion of browsing only albums of digital media data containing soundtracks,
a criterion of browsing only albums of digital media data containing explicit contents,
a criterion of browsing only albums of digital media data containing tributes,
a criterion of browsing only albums of edited digital media data.

5. The method of claim 1, wherein the displaying of at least a second user interface element to facilitate a user in establishing a context comprises displaying a user interface element having a list of genres for the user to select.

6. The method of claim 5, wherein the displaying of at least a second user interface element to facilitate a user in establishing a context further comprises displaying a user interface element having a list of subgenres of a selected one of the list of genres, for the user to select.

7. The method of claim 6, wherein the list of genres comprises a rock or pop genre, and the list of subgenres of the rock or pop genre comprises one or more of:
an adult alternative subgenre,
an adult contemporary subgenre,
an art and progressive subgenre,
a blues and boogie subgenre,
a classic rock subgenre,
a country rock subgenre,
a folk rock subgenre,
a funk rock subgenre,
a glam subgenre,
a hard rock subgenre,
an instrumental subgenre,
a jam rock subgenre,
a Latin subgenre,
a metal subgenre.

8. The method of claim 6, wherein the list of genres comprises an alternative or punk genre, and the list of subgenres of the alternative or punk genre comprises one or more of:
an alternative country subgenre,
an alternative dance subgenre,
an alternative metal subgenre,
a punk-funk subgenre, and
a post-punk subgenre.

9. The method of claim 6, wherein the list of genres comprises a rap or hip-hop genre, and the list of subgenres of the rap or hip-hop genre comprises one or more of:
an alternative rap or hip-hop subgenre,
a Christian rap or hip-hop subgenre,
a comedy rap or hip-hop subgenre,
a crossover rap or hip-hop subgenre, and
an East coast rap or hip-hop subgenre.

10. The method of claim 6, wherein the list of genres comprises a soul and rhythm and blue genre, and the list of subgenres of the soul and rhythm and blue genre comprises one or more of:
a classical rhythm and blue subgenre,
a contemporary rhythm and blue subgenre,
a Disco subgenre,
a Motown subgenre, and
a Soul subgenre.

11. The method of claim 6, wherein the list of genres comprises a country genre, and the list of subgenres of the country genre comprises one or more of:
a Country gospel subgenre,
a Country humor subgenre,
a Country pop/cosmopolitan subgenre,
a Country Rock subgenre, and
a Country Folk/Bluegrass subgenre.

12. The method of claim 6, wherein the list of genres comprises a jazz genre, and the list of subgenres of the jazz genre comprises one or more of:
Acid Jazz,
Avant Garde Jazz,
Big Band,
Blues Jazz, and
Cool or West Coast Jazz.

13. The method of claim 6, wherein the displaying of at least a second user interface element to facilitate a user in establishing a context comprises displaying on the display a user interface element having a collection of top albums of digital media data, a collection of new album releases, a collection of recommended albums, or a collection of top artists.

14. The method of claim 1, wherein said facilitating comprises displaying on the display a description of the currently applied criterion, a description of the current context within which the current criterion is applied, and one or more user interface elements correspondingly representing one or more albums of digital media data meeting the current criterion applied in the current context available for browsing.

15. The method of claim 1, wherein said facilitating comprises facilitating sampling of one or more portions of an album of digital media data being browsed.

16. The method of claim 1, further comprising updating a playlist of the user with an album of digital media data being browsed.

17. An apparatus comprising:
a processor; and
an album browsing module configured to be operated by the processor to facilitate browsing of albums of digital media data based at least on an indicated criterion applied in an indicated context, including operated by the processor to display on a display of an electronic device a first user interface element and facilitate a user in indicating a criteria using the first user interface element, the indicated criterion to be applied in browsing albums of digital media data, and to display on the display of the electronic device at least a second user interface element and to facilitate the user in establishing a context using the at least second user interface element, the established context to be employed to bound the application of the indicated criterion in browsing albums of digital media data.

18. The apparatus of claim 17, wherein the album browsing module is configured to display the first user interface element with a list of criteria for the user to select to indicate a criterion to be applied to browsing of albums of digital media data.

19. The apparatus of claim 17, wherein the album browsing module is configured to display the at least a second user interface element with a list of genres for the user to select and establish a context to apply the indicated criterion.

20. The apparatus of claim 19, wherein the album browsing module is further configured to display the at least a second user interface element with a list of subgenres of a selected one of the list of genres, for the user to select and establish a context to apply the indicated criterion.

21. The apparatus of claim 17, wherein the album browsing module is further configured to display on the display a description of the currently applied criterion, a description of the current context within which the current criterion is applied, and one or more user interface elements correspondingly representing one or more albums of digital media data meeting the current criterion applied in the current context available for browsing.

22. The apparatus of claim 17, wherein the album browsing module is further configured to facilitate sampling of one or more portions of an album of digital media data being browsed.

23. The apparatus of claim 17, the album browsing module further is further configured to update a playlist of the user with an album of digital media data being browsed.

24. The apparatus of claim 17, further comprising a plurality of albums of digital media data available for browsing under the facilitation of the medium album browsing module.

25. The apparatus of claim 17, further comprises a networking interface to couple the apparatus to a remotely disposed computing device having the display, and a communication module to operatively couple the networking interface to the processor.

26. A storage medium having stored therein a program product comprising a plurality of programming instructions configured to program an electronic device to enable the electronic device to practice a method that comprises:
displaying on a display a first user interface element to facilitate a user in indicating a criterion to be applied in browsing albums of digital media data,
displaying on the display at least a second user interface element to facilitate a user in establishing a context in applying the criterion in browsing albums of digital media data, and
facilitating the user in browsing albums of digital media data based at least on a criterion indicated using the first user interface element and applied in a context indicated using the at least second user interface element.

27. The storage medium of claim 26, wherein the programming instructions are further configured to enable the electronic device to facilitate the user in indicating a criterion to be applied in browsing albums of digital media data and/or establishing a context in applying the criterion in browsing albums of digital media data, using an input device coupled with the electronic device.

28. The storage medium of claim 27, wherein the programming instructions are configured to enable the electronic device to display the first user interface element on the display with a list of criteria for the user to select, to facilitate the user in indicating a criterion to be applied to browsing of albums of digital media data.

29. The storage medium of claim 27, wherein the programming instructions are configured to enable the electronic device to display the at least second user interface element with a list of genres for the user to select, to facilitate the user in establishing a context to apply the indicated criterion.

30. The storage medium of claim 29, wherein the programming instructions are further configured to enable the electronic device to display the at least second user interface element with a list of subgenres of a selected one of the list of genres, for the user to select and establish a context to apply the indicated criterion.

31. The storage medium of claim 27, wherein the programming instructions are further configured to enable the electronic device to display on the display a description of the currently applied criterion, a description of the current context within which the current criterion is applied, and one or more user interface elements correspondingly representing one or more albums of digital media data meeting the current criteria applied in the current context available for browsing.

32. The storage medium of claim 27, wherein the programming instructions are further configured to enable the electronic device to facilitate sampling of one or more portions of an album of digital media data being browsed.

33. The storage medium of claim 27, wherein the programming instructions are further configured to enable the electronic device to update a playlist of the user with an album of digital media data being browsed.
